(19) United States
(12) Patent Application Publication
(10) Pub. No.: US 2009/0269588 A1
(43) Pub. Date: Oct. 29, 2009

(54) TRANSPARENT CONDUCTIVE FILM AND METHOD OF PRODUCING TRANSPARENT CONDUCTIVE FILM

(75) Inventors: Souko Fukahori, Yasu-shi (JP); Yutaka Kishimoto, Yasu-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/500,694

(22) Filed: Jul. 10, 2009

Related U.S. Application Data
(63) Continuation of application No. PCT/JP2008/064708, filed on Aug. 18, 2008.

(30) Foreign Application Priority Data
Sep. 5, 2007 (JP) 2007-230347

(51) Int. Cl. B32B 15/00; B32B 17/06; B32B 27/36

(52) U.S. Cl. 428/412; 428/702; 428/432; 428/446; 428/480; 428/473.5; 428/697

(57) ABSTRACT

A transparent conductive film made of ZnO includes a ZnO layer having a region having a granular crystal structure. The zinc oxide layer is doped with a group-III element. The dose of the group-III element is about 0.8 to about 11.5 weight percent on an oxide mass basis. The group-III element is at least one selected from the group consisting of Ga, Al, and In. The full width at half maximum of a ZnO (002) rocking curve is preferably about 10.5 degrees or less.

### BACKGROUND OF THE INVENTION

1. Field of the Invention

The present invention relates to transparent conductive films and methods of producing the transparent conductive films. The present invention particularly relates to a transparent conductive film made of zinc oxide (ZnO) and a method of producing the transparent conductive film.

2. Description of the Related Art

Recently, transparent electrodes have been widely used in flat panel displays and solar cells. The transparent electrodes are usually made of ITO (indium tin oxide).

However, indium (In) is expensive and its availability is diminishing. Therefore, there are increasing demands for transparent electrodes made of other materials. ZnO-based transparent electrodes, which are In-free transparent electrodes, are being developed because the ZnO-based transparent electrodes are made of an oxide (ZnO) of zinc (Zn), which is inexpensive and readily available.

Although stoichiometric ZnO is an insulator, excess electrons due to oxygen defects and element replacement (doping) at a Zn site allow ZnO to be conductive. Transparent electrodes which are made of ZnO and which have a resistivity ρ of 10⁻⁴ Ωcm can presently be prepared.

Conventional ZnO-based transparent conductive films have a problem in that the moisture resistance thereof is insufficient for practical use. That is, the conventional ZnO-based transparent conductive films include a large number of oxygen defects and therefore have a problem in that the adsorption of moisture of the oxygen defects (re-oxidation of the oxygen defects) reduces the number of carriers to cause an increase in resistance if the ZnO-based transparent conductive films remain in high-humidity environments. One of the standards for the humidity resistance of an ITO transparent electrode is that the change in resistance of the ITO transparent electrode is ±10% after the ITO transparent electrode is left in an atmosphere with a relative humidity of 85% at 85° C. for 720 h. However, no ZnO-based transparent conductive films meeting this standard have been obtained.

If a ZnO-based transparent conductive film is formed on a flexible substrate, which may be used for various applications, there is a problem in that the transparent conductive film is seriously deteriorated by moisture because the flexible substrate is permeable to moisture and therefore not only the moisture present on a surface of the transparent conductive film but also the moisture passing through the flexible substrate affect the transparent conductive film.

In order to solve the problems described above, various techniques for improving the moisture resistance of ZnO-based transparent conductive films have been investigated. The techniques are roughly categorized into the following two groups:
(1) Techniques for preventing moisture from passing through substrates using SiN barrier layers; and
(2) Techniques for improving the quality (crystallinity) of ZnO films by heating.

However, no ZnO-based transparent conductive film with moisture resistance sufficient for practical use has yet been obtained.

Proposed techniques for imparting conductivity to ZnO by element doping are as described below.
(a) A technique in which the electrical resistance of a ZnO film is reduced with high controllability such that the ZnO film is doped with an impurity using a molecular beam of a group-IA element (H), a group-IIIA element (B, Al, Ga, or In), or a group-VIIA element (F, Cl, I, or Br) when the ZnO film is prepared using a molecular beam of ZnO or molecular beams of Zn and O (refer to Japanese Unexamined Patent Application Publication No. 8-050815).
(b) A transparent conductive body which includes ZnO doped with a group-VB or -VIB element in the periodic table and which includes a substrate and a transparent conductive film including the element, the transparent conductive film being disposed on the substrate, the number of atoms of the element being 0.1% to 10% of the sum of the number of the element atoms and that of zinc atoms (refer to Japanese Unexamined Patent Application Publication No. 8-050815).
(c) An organic EL element which includes a substrate, an anode disposed on the substrate, a cathode, and an organic layer disposed between the anode and the cathode and in which the anode includes a transparent conductive film made of a material containing one or more of oxides of Ir, Mo, Mn, Nb, Os, Re, Ru, Rh, Cr, Fe, Pt, Ti, W, and V (refer to Japanese Unexamined Patent Application Publication No. 11-067459).
(d) A transistor including a transparent conductive material, such as conductive ZnO, doped or undoped with any one of group-II, -VII, -I, and -V elements (refer to Japanese Unexamined Patent Application Publication No. 2000-150900).
(e) A transparent conductive film prepared by doping a zinc oxide thin film, having a c-axis/a-axis orientation ratio of 100:1 or more, with at least one of group-VII and -III compounds containing aluminum, gallium, or boron (refer to Japanese Unexamined Patent Application Publication No. 2000-276943).
(f) An indium zinc oxide hexagonal layered compound which is represented by the formula (ZnO)m.In₂O₃ (m=2 to 20), in which In or Zn is replaced with at least one selected from the group consisting of Sn, Y, Ho, Pb, Bi, Li, Al, Ga, Sb, Si, Cd, Mg, Co, Ni, Zr, Hf, Sc, Yb, Lu, Fe, Nb, Ta, W, Te, Au, Pt, and Ge, and which has an average thickness of 0.001 to 0.3 μm and an average aspect ratio (average major diameter/average thickness) of three to 1000 (refer to WO 2001/056927).

Known ZnO films which are formed by depositing zinc oxide particles prepared by oxidizing zinc particles generated by sputtering and which have columnar crystal structures (refer to Japanese Unexamined Patent Application Publication No. 2006-5115). Japanese Unexamined Patent Application Publication No. 2006-5115 discloses that each of the ZnO films have a columnar crystal structure shown in FIG. 8 or 9 thereof. The reason why common ZnO films usually have a columnar crystal structure is probably that the (002) plane of a ZnO hexagonal crystal is extremely energetically stable and grains grow primarily at the (002) plane thereof.

The known ZnO-based transparent conductive films have the problems described above relating to moisture resistance.

Under these circumstances, the inventors of the present invention discovered that the crystal structure of ZnO has a significant effect on humidity resistance. The inventors of the present invention have proposed a transparent conductive film prepared by growing zinc oxide (ZnO) heavily doped with a group-III element on a substrate and a method of producing the transparent conductive film (refer to WO 2007/080738). The transparent conductive film is different in configuration from that according to the present invention, is heavily doped with an impurity, has c-axes extending in different directions, and has excellent humidity resistance.

### SUMMARY OF THE INVENTION

To overcome the problems described above, preferred embodiments of the present invention provide a ZnO-based transparent conductive film which is obtained by a method different from an impurity heavily doping method, which has humidity resistance sufficient for practical use and properties necessary for transparent conductive films, and which is cost-effective, and a method of producing the ZnO-based transparent conductive film.

The inventors of the present invention have formed various films by varying conditions using targets including group-III elements. The inventors have discovered that a ZnO layer having a granular crystal structure, which was not known before and is different from a common the conventional columnar crystal structure. This new ZnO layer having the unique granular crystal structure has excellent humidity resistance. As is well known, a ZnO layer having the conventional columnar crystal structure includes grains that extend continuously between a substrate interface and a surface of the ZnO layer. In contrast, the ZnO layer having the novel granular crystal structure includes grains that do not extend continuously between the substrate interface and the surface of the ZnO layer. The inventors have further performed experiments and investigations and have invented and developed preferred embodiments of the present invention as a result.

A transparent conductive film according to a preferred embodiment of the present invention includes a zinc oxide (ZnO) layer grown on a substrate. The zinc oxide layer includes a region having a granular crystal structure.

Preferably, the zinc oxide layer is doped with a group-III element.

In the transparent conductive film, the dose of the group-III element is preferably about 0.8 to about 11.5 weight percent on an oxide mass basis.

The full width at half maximum of a ZnO (002) rocking curve is preferably about 10.5 degrees or less.

The substrate is preferably made of at least one selected from the group consisting of glass, quartz, sapphire, Si, SiC, polyethylene terephthalate (PET), polyethylene naphthalate (PEN), polyethersulfone (PES), polyimide, cycloolefinic polymers, and polycarbonate.

The group-III element is preferably at least one selected from the group consisting of Ga, Al, and In.

A transparent conductive film according to a preferred embodiment of the present invention includes a zinc oxide layer having a granular crystal structure. The transparent conductive film is grown on a substrate. This allows the transparent conductive film to have excellent humidity resistance and prevents the resistivity thereof from being deteriorated over time. A transparent conductive film having good humidity resistance and stable properties can be obtained such that a ZnO layer is formed on a glass substrate by growing a granular crystal. The resistivity of this transparent conductive film does not significantly vary after a lapse of about 200 hours even if the doping concentration of Al is low, for example, about 3.0% by weight.

The zinc oxide layer is doped with a group-III element as described above. This securely provides a ZnO-based transparent conductive film which has humidity resistance sufficient for practical use and which is cost-effective.

The dose of the group-III element is preferably about 0.8 to about 11.5 weight percent on an oxide mass basis. Therefore, a practical transparent conductive film which has excellent humidity resistance and of which the resistivity does not significantly vary over time is provided.

A transparent conductive film is formed such that the doping concentration of the group-III element is controlled to be low such that the growth of C-axis columnar crystals is prevented and granular crystals are grown. Therefore, a practical transparent conductive film having low resistivity and excellent humidity resistance and of which the resistivity does not significantly vary over time is provided.

When the dose of the group-III element is less than about 0.8 weight percent or greater than about 11.5 weight percent on an oxide mass basis, the resistivity is likely to be increased. Therefore, the dose of the group-III element is preferably about 0.8 to about 11.5 weight percent on an oxide mass basis.

The full width at half maximum of a ZnO (002) rocking curve is preferably about 10.5 degrees or less. Therefore, the resistivity can be maintained at a low level because the crystal orientation in grains is good.

The full width at half maximum of the ZnO (002) rocking curve correlates with the dose of the group-III element. When the dose of the group-III element is greater than about 11.5 weight percent on an oxide mass basis, the full width at half maximum of the ZnO (002) rocking curve is greater than about 10.5 degrees and the resistivity is likely to increase. Therefore, the dose of the group-III element is preferably controlled such that the full width at half maximum of the ZnO (002) rocking curve does not exceed about 10.5 degrees.

In the transparent conductive film according to a preferred embodiment of the present invention, the substrate is preferably made of at least one selected from the group consisting of glass, quartz, sapphire, Si, SiC, polyethylene terephthalate (PET), polyethylene naphthalate (PEN), polyethersulfone (PES), polyimide, cycloolefinic polymers, and polycarbonate as described in claim 5. The substrate can be used to form a ZnO-based transparent conductive film thereon. The ZnO-based transparent conductive film has humidity resistance that is sufficient for practical use and is cost-effective.

The group-III element is preferably at least one selected from the group consisting of Ga, Al, and In as described in claim 6. Therefore, a ZnO-based transparent conductive film which has humidity resistance that is sufficient for practical use and which is cost-effective can be produced.

In view of achieving sufficiently low resistivity, the group-III element (doping element) is most preferably Al or Ga. The use of In, which is another group-III element, is effective in achieving an advantage similar to that achieved by the use of Al or Ga.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic view of an off-axis sputtering system used to form a ZnO layer which defines a transparent conductive film according to a first preferred embodiment of the present invention.

FIG. 2 is a SEM image illustrating the crystal structure (a structure in which granular crystals are grown) of the ZnO layer according to the first preferred embodiment of the present invention.

FIG. 3 is a SEM image illustrating the crystal structure (a structure in which columnar crystals are grown) of a ZnO layer (transparent conductive film) according to a comparative example.

FIG. 4 is a graph illustrating the temporal change in the resistivity of each ZnO layer according to the first preferred embodiment and that of each ZnO layer according to the comparative example.

FIG. 5 is a graph illustrating the relationship between the dose of a group-III element and the resistivity of each ZnO layer.

FIG. 6 is a graph illustrating the relationship between the dose of a group-III element and the full width at half maximum (FWHM) of the ZnO (002) rocking curve of each ZnO layer.

### DETAILED DESCRIPTION OF PREFERRED EMBODIMENTS

A transparent conductive film according to preferred embodiments of the present invention and a method of producing the transparent conductive film will now be described in detail.

First, the method of producing the transparent conductive film which includes a zinc oxide (ZnO) layer is described. The transparent conductive film is produced by using an off-axis sputtering system.

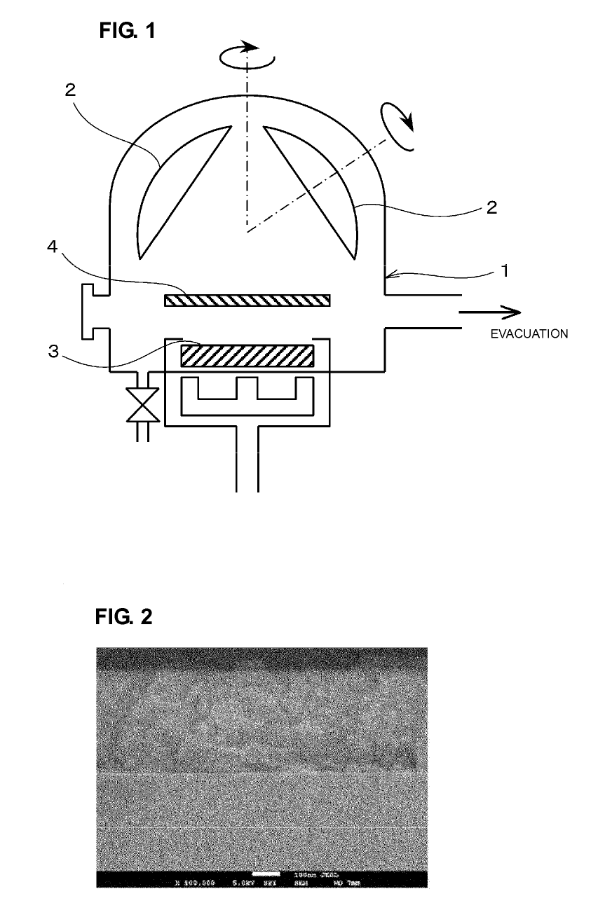

FIG. 1 shows the schematic configuration of the off-axis sputtering system.

The off-axis sputtering system includes a deposition chamber 1, a holder (substrate holder) 2 which is disposed in the deposition chamber 1 and which holds a substrate (not shown) to be coated with the ZnO layer, a target 3 disposed in the deposition chamber 1, and a shutter 4 arranged between the target 2 and the substrate, which is held with the holder 2. The deposition chamber 1 is configured such that the deposition chamber 1 can be evacuated and the target 3 can be supplied with pulsed DC power.

The off-axis sputtering system is configured such that the layer can be formed such that the substrate, which has a surface for growing the layer, is arranged outside a space which is located in a direction perpendicular or substantially perpendicular to the target and in which high-energy particles are provided with high probability. The off-axis sputtering system is capable of forming the layer such that the composition of the layer is controlled such that the layer composition does not significantly differ from the composition of the target.

The target 3 preferably has a sintered density of at least about 80%, a two-dimensional size of about 315 mm×about 118 mm, and a thickness of about 5 mm, for example.

The substrate preferably is made of at least one selected from the group consisting of glass, quartz, sapphire, Si, SiC, polyethylene terephthalate (PET), polyethylene naphthalate (PEN), polyethersulfone (PES), polyimide, cycloolefinic polymers, and polycarbonate. Even if the substrate is made of any one of the above materials, the substrate is surface-cleaned in advance of deposition such that the substrate is washed with isopropyl alcohol and irradiated with UV light.

The substrate is set in the deposition chamber 1 of the off-axis sputtering system and the deposition chamber 1 is then evacuated to about 5.5×10⁻⁵ Pa.

After evacuation, a high-purity Ar gas used as a sputtering gas is introduced into the deposition chamber 1 such that the pressure therein is increased to a predetermined value.

The target 3 is sputtered such that a pulsed DC power with a predetermined pulse width is applied to the target 3 at a predetermined frequency.

The thickness of a layer obtained by sputtering is set to about 400 nm. The obtained ZnO layer is patterned by wet etching and measured for thickness with a probe profilometer, whereby the ZnO layer is checked to determine whether the ZnO layer has a set thickness. The ZnO layer is analyzed for composition, whereby the ZnO layer is checked to determine whether the composition thereof is the same or substantially as that of the target. Layers prepared in the preferred embodiment or the comparative examples each had a thickness substantially equal to a set thickness and the difference of the composition of each layer from that of a target was at an acceptable level.

Variable sputtering conditions are primarily the composition of the target (the type and dose of a group-III element), the type of the substrate, the pressure in the chamber, the rotation speed of the substrate, a pulsed DC power, a pulse width, and a pulse frequency.

### FIRST PREFERRED EMBODIMENT

FIG. 2 is a cross-sectional SEM image of an Al-doped ZnO (AZO) layer, according to a first preferred embodiment of the present invention, having a granular crystal structure. The ZnO layer was prepared under the following conditions.
Target: ZnO-mixed sintered body including about 3.0 weight percent Al₂O₃
Type of substrate: alkali-free glass (Corning 1737)
Pressure in chamber: about 0.1 Pa
Rotation of substrate: not rotated
Pulsed DC power: about 2000 W
Pulse width: about 2 μs
Pulse frequency: about 100 kHz

The following layer was confirmed to have a granular crystal structure of a Ga-doped ZnO (GZO) layer, which is not shown, prepared using a ZnO-mixed sintered body including 5.7 weight percent Ga₂O₃ used as a target.

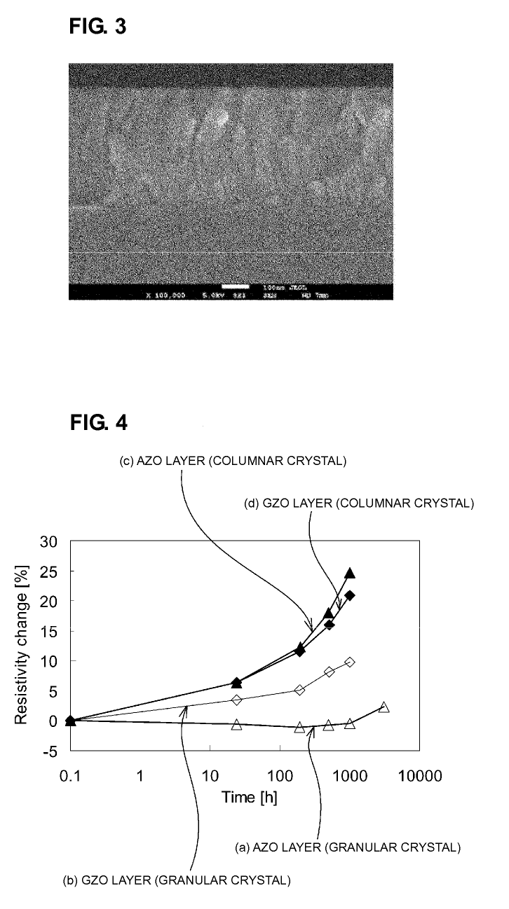

A ZnO layer having a conventional columnar crystal structure was obtained under conditions that somewhat different from the above conditions, for example, under a condition such that a substrate was rotated at about 10 rpm. FIG. 3 is a cross-sectional SEM image of an Al-doped ZnO (AZO) layer according to a comparative example having a columnar crystal structure. A Ga-doped ZnO (GZO) layer, which is not shown, was confirmed to have a columnar crystal structure.

As described above, it was discovered that slight changes in production conditions produce ZnO layers having different crystal structures. However, it is not sufficiently clear what mechanism interrupts crystal growth on the (002) plane, which is extremely stable, so as to create a granular crystal structure.

### Resistivity of ZnO Layer

The ZnO layers according to a preferred embodiment of the present invention and the comparative example were measured for resistivity by a four-probe technique.

### (1) Resistivity of ZnO Layer According To A Preferred Embodiment

The resistivity of each ZnO layer formed as described above was confirmed to be a value below.
Resistivity of Al-doped ZnO (AZO) layer: about 9.9×10⁻⁴ Ωcm
Resistivity of Ga-doped ZnO (GZO) layer: about 7.1×10⁻⁴ Ωcm

### (2) Resistivity of ZnO Layer According To Comparative Example

The resistivity of each ZnO layer formed in the comparative example as described above was confirmed to be a value below.
Resistivity of Al-doped ZnO (AZO) layer: about 9.3×10⁻⁴ Ωcm
Resistivity of Ga-doped ZnO (GZO) layer: about 7.9×10⁻⁴ Ωcm

### Sheet Resistance

The ZnO layers according to a preferred embodiment of the present invention and the comparative example were measured for sheet resistance.

### (1) Sheet Resistance of ZnO Layer According To A Preferred Embodiment

The sheet resistance of each ZnO layer formed in a preferred embodiment of the present invention as described above was confirmed to be a value below.
Sheet resistance of Al-doped ZnO (AZO) layer: about 27 Ω/square
Sheet resistance of Ga-doped ZnO (GZO) layer: about 19 Ω/square
   (2) Sheet Resistance of ZnO layer According to Comparative Example

The sheet resistance of each ZnO layer formed in the comparative example as described above was confirmed to be a value below.
Sheet resistance of Al-doped ZnO (AZO) layer: about 23 Ω/square
Sheet resistance of Ga-doped ZnO (GZO) layer: about 19 Ω/square

### Transmittance at Visible Wavelengths

The ZnO layers according to a preferred embodiment of the present invention and the comparative example were measured for transmittance at visible wavelengths. All of the ZnO layers were confirmed to have a transmittance of at least about 80% at visible wavelengths.

### Change In Resistivity With Time

The ZnO layers according to a preferred embodiment of the present invention and Comparative Example, that is, the following layers were measured for changes in the resistivity over time in an atmosphere with a relative humidity of about 85% at about 85° C.:
(a) the Al-doped ZnO (AZO) layer including the granular crystalline region,
(b) the Ga-doped ZnO (GZO) layer including the granular crystalline region,
(c) the Al-doped ZnO (AZO) layer including the columnar crystalline region, and
(d) the Ga-doped ZnO (GZO) layer including the columnar crystalline region.

The measurement results are shown in FIG. 4.

FIG. 4 confirms that the granular crystalline region-including Al-doped ZnO (AZO) layer specified in Item (a) and the granular crystalline region-including Ga-doped ZnO (GZO) layer specified in Item (b) have a small change in resistivity with time and the columnar crystalline region-including Al-doped ZnO (AZO) layer specified in Item (c) and the columnar crystalline region-including Ga-doped ZnO (GZO) layer specified in Item (d), however, have a large change in resistivity with time.

### SECOND PREFERRED EMBODIMENT

Several types of targets having different Al₂O₃ or Ga₂O₃ contents were prepared. ZnO layers were formed under conditions similar to those described in the first preferred embodiment using the targets such that the dose of each group-III element was varied in four steps: about 3.0, about 5.7, about 10.0, and about 15.0 weight percent on an oxide mass basis.

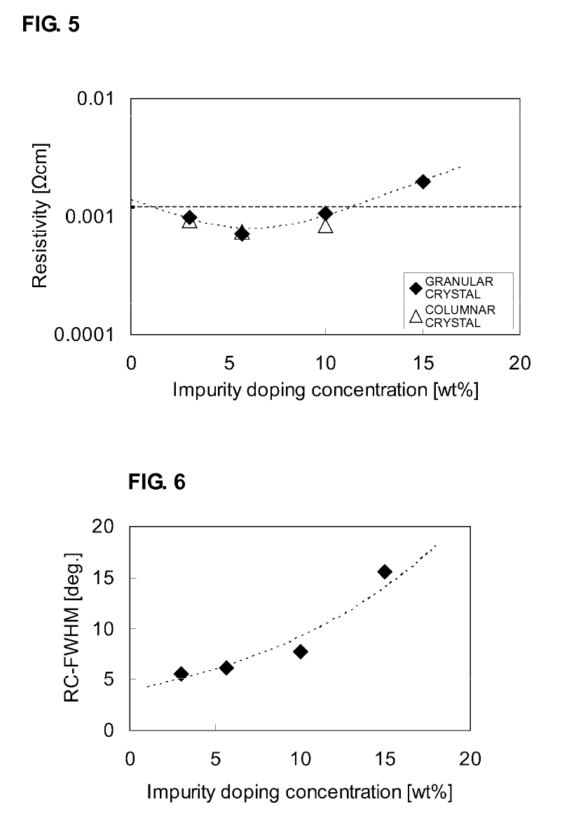

The obtained ZnO layers were used to investigate the relationship between the dose of the group-III element and the resistivity of the ZnO layers. FIG. 5 shows the data obtained using Al, which is a group-III element.

It is commonly known that a ZnO layer, used as a transparent conductive film, for practical use has a resistivity of about 1.2×10⁻³ Ωcm or less. FIG. 5 confirms that the resistivity is about 1.2×10⁻³ Ωcm or less when the dose of the group-III element is within a range from about 0.8 to about 11.5 weight percent, for example.

Therefore, the dose of the group-III element is preferably within a range from about 0.8 to about 11.5 weight percent on an oxide mass basis, for example.

FIG. 5 shows the data obtained using Al, which is a group-III element. The second preferred embodiment confirms that the relationship between the dose of the group-III element and the resistivity of the ZnO layers does not significantly vary even if the group-III element is Al or Ga.

The ZnO layers of the second preferred embodiment, which are different in the dose of each group-III element from the ZnO layers of the first preferred embodiment, are confirmed to have the granular crystal structure even if the dose of the group-III element is zero, although the crystal structures are not shown.

### THIRD PREFERRED EMBODIMENT

Several types of targets having different Al₂O₃ or Ga₂O₃ contents were prepared in substantially the same manner as that described in second preferred embodiment. ZnO layers were formed under conditions similar to those described in the first preferred embodiment using the targets such that the dose of each group-III element was varied in four steps: about 3.0, about 5.7, about 10.0, and about 15.0 weight percent on an oxide mass basis.

The obtained ZnO layers were used to investigate the relationship between the dose of the group-III element and the full width at half maximum (FWHM) of the ZnO (002) rocking curve of each ZnO layer. FIG. 6 shows the data obtained using Al, which is a group-III element.

The second preferred embodiment confirms that in order to enable the ZnO layers to have a resistivity suitable for use as transparent conductive films, the dose of the group-III element is preferably within a range from about 0.8 to about 11.5 weight percent on an oxide mass basis as described above. The third preferred embodiment (FIG. 6) confirms that the full width at half maximum (FWHM) of the ZnO (002) rocking curve is preferably about 10.5 degrees or less, for example.

The third preferred embodiment confirms that in order to enable the ZnO layers to have a resistivity of about 1.2×10⁻³ Ωcm suitable for use as transparent conductive films, the full width at half maximum (FWHM) of the ZnO (002) rocking curve is preferably about 10.5 degrees or less, for example.

FIG. 6 shows the data obtained using Al, which is a group-III element. The third preferred embodiment confirms that the relationship between the dose and the full width at half maximum (FWHM) of the ZnO (002) rocking curve of each ZnO layer does not significantly vary even if the group-III element is Al or Ga.

### FOURTH PREFERRED EMBODIMENT

Substrates (flexible substrates) made of PEN (polyethylene naphthalate) were used instead of the glass substrate, made of alkali-free glass, used in the first preferred. ZnO layers (transparent conductive films) doped with Al or Ga were formed on the flexible substrates under the same conditions as those described in one of the first to third preferred embodiments in the same manner as that described in one of the first to third preferred embodiments.

The obtained ZnO layers (transparent conductive films) were characterized under substantially the same conditions as those described in one of the first to third preferred embodiments. This confirmed that the ZnO layers (transparent conductive films) had substantially the same properties as those described in one of the first to third preferred embodiments.

The ZnO layers (not shown) of the fourth preferred embodiment were confirmed to have a granular crystal structure.

This confirms that a practical transparent conductive film can be formed on a substrate (flexible substrate) made of PEN (polyethylene naphthalate), which is versatile.

### FIFTH PREFERRED EMBODIMENT

Substrates (flexible substrates) made of PET (polyethylene terephthalate) were used instead of the glass substrate, made of alkali-free glass, used in the first preferred embodiment. ZnO layers (transparent conductive films) doped with Al or Ga were formed on the flexible substrates under substantially the same conditions as those described in one of the first to third preferred embodiments in the same manner as that described in one of the first to third preferred embodiments.

The obtained ZnO layers (transparent conductive films) were characterized under substantially the same conditions as those described in one of the first to third preferred embodiments. This confirmed that the ZnO layers (transparent conductive films) had substantially the same properties as those described in one of first to third preferred embodiments.

The ZnO layers of fifth preferred embodiment were confirmed to have a granular crystal structure, although the crystal structures are not shown.

This confirms that a practical transparent conductive film can be formed on a substrate (flexible substrate) made of PET (polyethylene terephthalate), which is versatile.

In the first to fifth preferred embodiments, the ZnO layers (transparent conductive films) were formed on the glass substrates, the PEN substrates, or the PET substrates. A ZnO layer (transparent conductive film) according to preferred embodiment of the present invention may preferably be formed on a single-crystalline substrate made of quartz, sapphire, or Si or a substrate made of SiC, polyethersulfone (PES), polyimide, a cycloolefinic polymer, or polycarbonate. The use of such a substrate provides substantially the same advantages as those obtained by the use of the glass substrates.

The conditions described in the first to fifth preferred embodiments are preferred exemplary conditions capable of efficiently growing granular crystals. Among conditions such as a chamber pressure, the dose of a group-III element and the type of a substrate are not dominant conditions in growing granular crystals. Among the conditions used through in the first to fifth preferred embodiments, it is unclear which condition is dominant. In order to grow granular crystals, overall conditions including several sub-conditions probably need to be optimized. Even if the overall conditions are different from those described in the first to fifth preferred, granular crystals can probably be grown as long as the overall conditions are optimized.

The present invention is not limited to the above-described preferred embodiments. The shape of a substrate for forming a ZnO layer (transparent conductive film), the type of a material for forming the substrate, the type and dose of a group-III element, and conditions for forming the ZnO layer may be variously adapted or modified within the scope of the present invention.

As described above, according to various preferred embodiments of the present invention, a ZnO-based transparent conductive film can be efficiently and securely produced. The ZnO-based transparent conductive film has humidity resistance sufficient for practical use and properties necessary for transparent conductive films, and is cost-effective.

Accordingly, the present invention can be widely used for various applications, such as transparent electrodes for flat panel displays or solar cells, for example.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A transparent conductive film comprising:
a zinc oxide layer grown on a substrate; wherein
the zinc oxide layer includes a region having a granular crystal structure.

2. The transparent conductive film according to claim 1, wherein the zinc oxide layer is doped with a group-III element.

3. The transparent conductive film according to claim 2, wherein a dose of the group-III element is about 0.8 to about 11.5 weight percent on an oxide mass basis.

4. The transparent conductive film according to claim 1, wherein a full width at half maximum of a zinc oxide (002) rocking curve is preferably about 10.5 degrees or less.

5. The transparent conductive film according to claim 1, wherein the substrate is made of at least one selected from the group consisting of glass, quartz, sapphire, Si, SiC, polyethylene terephthalate, polyethylene naphthalate, polyethersulfone, polyimide, cycloolefinic polymers, and polycarbonate.

6. The transparent conductive film according to claim 1, wherein the group-III element is at least one selected from the group consisting of Ga, Al, and In.
